(19) United States
(12) Patent Application Publication
(10) Pub. No.: US 2008/0007222 A1
(43) Pub. Date: Jan. 10, 2008

(54) Low cost ultra low power in-battery charge monitor

(76) Inventors: Jasper Nance, Moscow, ID (US); Herb Hess, Moscow, ID (US)

Correspondence Address: KLARQUIST SPARKMAN, LLP, 121 SW SALMON STREET, SUITE 1600, PORTLAND, OR, 97204, US

(21) Appl. No.: 11/811,283

(22) Filed: Jun. 8, 2007

Related U.S. Application Data
(60) Provisional application No. 60/812,186, filed on Jun. 9, 2006.

(51) Int. Cl. H02J 7/00

(52) U.S. Cl. 320/128

(57) ABSTRACT

Battery monitoring systems include a microprocessor and a current sensor that is coupled to periodically sample current provided by the battery. Based on the periodic samples and an initial battery capacity, the microprocessor determines a remaining battery capacity. The microprocessor and current sensor are powered by the battery being monitored, and to reduce power consumption, periodic current sensings alternate with periodic sleep periods in which the current sensor and the microprocessor are substantially disabled or operate with substantially reduced power consumption.

### CROSS REFERENCE TO RELATED APPLICATION

This application claims the benefit of U.S. Provisional Application No. 60/812,186, filed Jun. 9, 2006, which is incorporated herein by reference.

### ACKNOWLEDGMENT OF GOVERNMENT SUPPORT

This invention was funded in part by the National Aeronautics and Space Administration under grant number NCC5-577. The United States Government has certain rights in the invention.

### FIELD

The disclosure pertains to battery monitors.

### BACKGROUND

The miniaturization of electronic equipment has permitted the development of portable equipment with reduced power consumption. Unfortunately, as miniaturization continues, the power demands on and overall complexity of portable circuitry tends to increase. As a result, power systems for portable equipment continue to face capacity challenges.

In response to demands for batteries and other devices that can provide power for portable equipment, battery manufacturers have investigated many alternative battery configurations that can provide additional portable power. One battery that offers significant volume energy density, low mass, and that can be disposed of without significant environmental concerns is the so-called zinc-oxygen battery. Not only do these batteries offer superior energy densities to many conventional batteries, such batteries begin to age only when exposed to oxygen. Zinc-oxygen batteries can be sealed in vacuum packaging that is opened upon installation, so that battery aging begins only upon installation. Thus, zinc-oxygen battery shelf life can be very long.

In contrast to many conventional batteries, the output voltage of a zinc-oxygen battery tends to remain constant throughout the life of the battery. In some cases, the output voltage increases or decreases slightly as the battery is used, and battery voltage decreases abruptly only at the end of the battery life. Thus, such batteries provide high power capacities at a relatively constant voltage and serve as convenient power sources for a variety of industrial, educational, recreational, and military equipment.

While the substantially constant zinc-oxygen battery output voltage is advantageous in powering equipment, this constant output voltage prevents remaining battery life from being readily estimated based on the gradual voltage decreases associated with use typical of other types of batteries. Moreover, most sophisticated methods of estimating battery life needed for such batteries required substantial amounts of electrical power for their operation. These power-intensive methods may be suitable for testing during manufacturing or for some fixed installations, but in most applications, battery power must be conserved to power operational equipment, and should not be wasted on assessing the battery itself. This disclosure is directed to methods and apparatus that can provide suitable battery monitoring, especially at remote locations, contrary to the conventional wisdom that such battery monitoring will substantially reduce battery lifetime.

### SUMMARY

Representative methods and apparatus are described herein to illustrate some principles and applications of the disclosed technology. These representative methods and apparatus are selected as illustrative, and the disclosure is not limited to these examples.

In some representative examples, apparatus include a current sensor configured to detect a battery current and provide an associated sensed current signal. A controller is coupled to receive the sensed current signal and determine battery capacity usage in a corresponding time interval. The controller is further configured to estimate a remaining battery capacity based on the battery capacity usage and a stored battery capacity, and both the current sensor and the controller are coupled so as to be powered by the battery. In other examples, an indicator is configured to communicate the estimated battery capacity to a user in response to a user request. In further examples, the controller is configured to alternately establish a sleep mode in which the current sensor is disabled and power consumption of the controller is reduced, and a sensing mode in which battery current is sensed. In additional examples, the current sensor is configured to provide the sensed current signal as a pulse width modulated signal, and the controller includes an analog to digital converter configured to establish a digital representation of the sensed current signal, and the estimated remaining battery capacity is determined based on the digital representation. In further examples, the current sensor is configured to periodically detect the battery current and provide periodic sensed current signals, wherein the controller is configured to operate at a reduced power setting between the periodic detections. In some examples, the indicator is a visual indicator, and includes at least one light emitting diode that is activated based on the estimated remaining battery capacity. In further examples, an oxygen sensor is coupled to the controller and configured to detect battery activation. In additional representative examples, the controller includes a memory configured to store a capacity of the battery.

Methods comprise alternately detecting a current provided by a battery with a current sensor and substantially disabling the current sensor, and based on the detected current, estimating a remaining battery capacity. In further examples, an initial battery capacity is stored and the remaining battery capacity is determined based on the initial battery capacity. According to some examples, an updated battery capacity is stored based on the detected current. In other examples, the remaining battery capacity is determined based on at least one environmental sensor. In some representative examples, a ratio of a time interval associated with current sensing to a time interval associated with the disabled current sensor is less than about 0.2, 0.1, 0.05, or 0.01. According to additional representative examples, electrical power is provided to the current sensor with the battery.

In other examples, apparatus comprise a battery and a periodically activated current sensing system coupled to the battery and configured to provide an estimate of remaining battery capacity based on periodically sensed current values. In some examples, the current sensing system includes a memory configured to store an initial battery capacity, and the estimate of remaining battery capacity is based on the initial battery capacity. In still further examples, a battery activation sensor is coupled to indicate battery activation, and the remaining battery capacity is estimated based on an elapsed activation time. In further embodiments, a voltage regulator is configured to provide an operational voltage to the current sensing system. In some additional examples, the current sensor includes a microprocessor and a field effect transistor configured to periodically disable the current sensor, and the battery is a zinc-oxygen battery.

The foregoing and other objects, features, and advantages of the disclosed technology will become more apparent from the following detailed description, which proceeds with reference to the accompanying figures drawings.

### BRIEF DESCRIPTION OF THE DRAWINGS

FIG. 1 is a block diagram of a representative in-battery monitoring system.

FIG. 2 is a block diagram of a representative in-battery charge monitor.

FIG. 3 is a block diagram of a portion of a representative battery charge monitor.

FIG. 4 is a block diagram illustrating a method of battery monitoring.

FIG. 5 is a schematic diagram of representative battery monitoring circuitry.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” means electrically or electromagnetically coupled or linked and does not exclude the presence of intermediate elements between the coupled items.

The described systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Representative examples described below typically refer to systems and methods adapted to monitoring life expectancy of so-called zinc-oxygen batteries. These batteries can provide a total current-time product (extracted charge) that can be established based on manufacturing conditions and are not rechargeable. In addition, in normal operation the voltage provided by such batteries is relatively constant throughout the life of the battery, and remaining battery life cannot be satisfactorily estimated based on battery voltage. In other examples, rechargeable batteries or batteries that exhibit appreciable voltage changes as the battery is operated can be used. In examples based on rechargeable batteries, currents and/or voltages provided during battery charging can be sensed, and battery capacity estimated based on the sensed values.

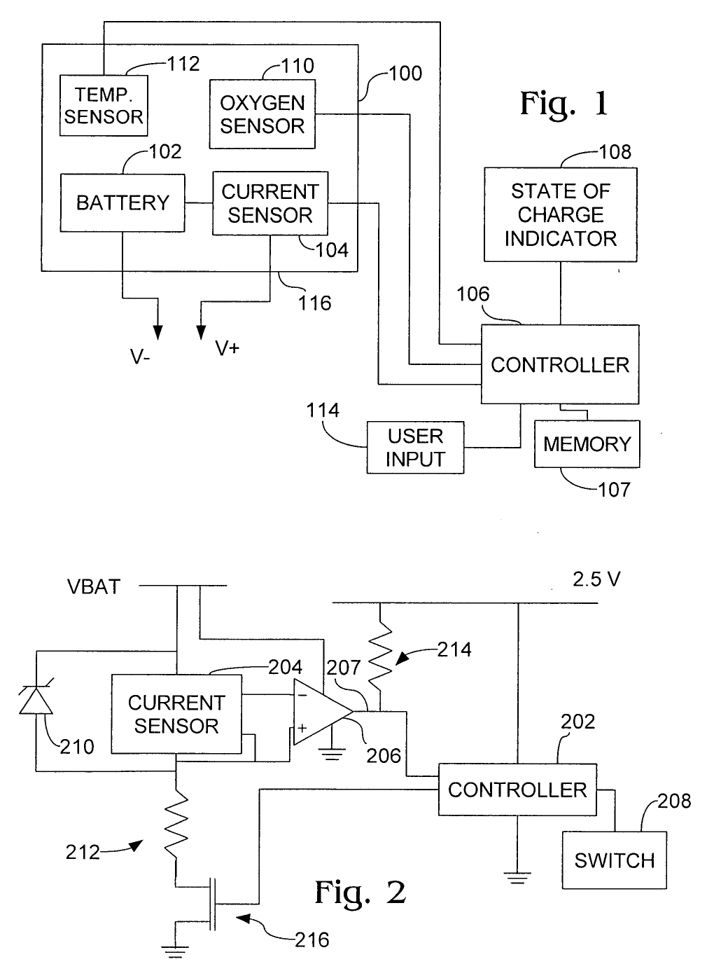

With reference to FIG. 1, a representative power-monitored battery system 100 includes a battery 102 and a current sensor 104 coupled to sense a battery current and provide a sensor output to a controller 106. The controller 106 is coupled to a memory 107 that can store computer-executable instructions for charge monitor operation, determination of extracted charge, and battery life expectancy. For example, capacity or other characteristics of a particular battery can be stored in the memory 107 and remaining battery life reported based on the stored capacity and/or other characteristics. Updated values can also be stored in the memory 107 as the battery ages. The memory 107 can be provided as a separate memory circuit or can be included in the controller 106.

The controller 106 is coupled to a state of charge indicator 108 and additional sensors associated with battery operation or battery capacity such as, for example, an oxygen sensor 110 and a temperature sensor 112. The sensors 104, 110, 112 are conveniently secured to the battery 102 in a common housing 116 or other mechanical support.

The charge indicator 108 can be conveniently implemented as a series of light emitting diodes or other visual display components that can indicate a remaining battery capacity. Other types of indicators can be used as well, including indicators that provide tactile, audible, visual, or other indications that can be associated with extracted charge. Typically, the charge indicator 108 is enabled only in response to user activation at a user input 114 such as a switch or other input device so as to reduce power consumption in the charge indicator.

The current sensor 104 and controller 106 are generally powered by the battery 102. To reduce battery power consumed in battery monitoring, the current sensor 104 and the controller 106 are configured so as to sense battery current only at random or periodic intervals. The controller 106 is configured to estimate total extracted battery charge and remaining charge based on these sampled current values. In some examples, the controller 106 and the current sensor 102 are activated at a fixed periodic interval to provide substantially equally spaced current samples for extracted charge estimation. Between these sampling times, the controller 106 and the current sensor 104 operate in a reduced power or “sleep” mode to enhance battery life.

As shown in FIG. 1, the controller 114 is also coupled to additional sensors. For example, zinc-oxygen batteries are activated upon oxygen exposure, and battery life is a function of oxygen exposure. Thus, the oxygen sensor 110 permits battery life estimates based on activation time and oxygen exposure as well as extracted charge. Additional sensors provide values associated with other parameters related to battery life such as, for example, battery temperature and ambient humidity. The controller 106 can also be configured to determine, based on a sensed oxygen value, periods in which oxygen supplied to the battery limited battery output.

Referring to FIG. 2, a typical charge monitoring system includes a controller 202 that is coupled to receive electrical power from a battery to be monitored based on a battery voltage VBAT. A current sensor 204 provides a signal associated with a battery current sample to a comparator 206 that is coupled to the controller 202. The controller 202 can be configured to receive a signal associated with the sensed current at an analog-to-digital conversion input of the controller 202. The current sensor 204 can be provided power based on a voltage set by a zener diode 210 (in one example, a 3.3 V zener diode). A current limiting series resistor 212 is coupled to the zener diode and selected to provide sufficient current for zener diode bias and current sensor operation. An n-channel MOSFET 216 is coupled so as to interrupt or reduce current to the current sensor as instructed by the controller 202, typically during time intervals corresponding to a “sleep” mode in which battery monitor power consumption is reduced. During this “sleep” mode, the current sensor 204 is turned off and the controller 202 operates at reduced power consumption.

The comparator 204 receives electrical power from the battery as well, and provides an electrical signal associated with the battery current with respect to a virtual ground reference established by the zener diode 210 at a comparator output 207. A switch 208 is provided to trigger the controller 202 to display or otherwise indicate battery charge remaining, a rate of battery drain, an expected battery life remaining, or other indication of battery status.

A representative configuration for providing an indication of battery status is illustrated in FIG. 3. A switch 306, typically a push-button momentary contact switch, is coupled to a microcontroller 302 that provides one or more electrical signals associated with battery monitor indications to a display unit 304. In one example, the display unit comprises light emitting diodes (LEDs) 308, 310, 312, 314 that receive corresponding signals from the microcontroller 302. The LEDs can be arranged so that each diode corresponds to 25% of battery capacity. For example, if the battery is still at 100% capacity, all four LEDs are illuminated in response to switch activation while if capacity is at least about 75%, 50%, or 25%, three LEDs, two LEDs, or one LED can be illuminated. For example, LEDs 310, 312, 314 can be activated to indicate 75% charge remaining, LEDs 312, 314 can be activated in indicate 50% charge remaining, and LED 314 can be activated to indicate 25% charge remaining. In other examples, a single LED can be used and a blink rate or intensity used to indicate remaining battery capacity.

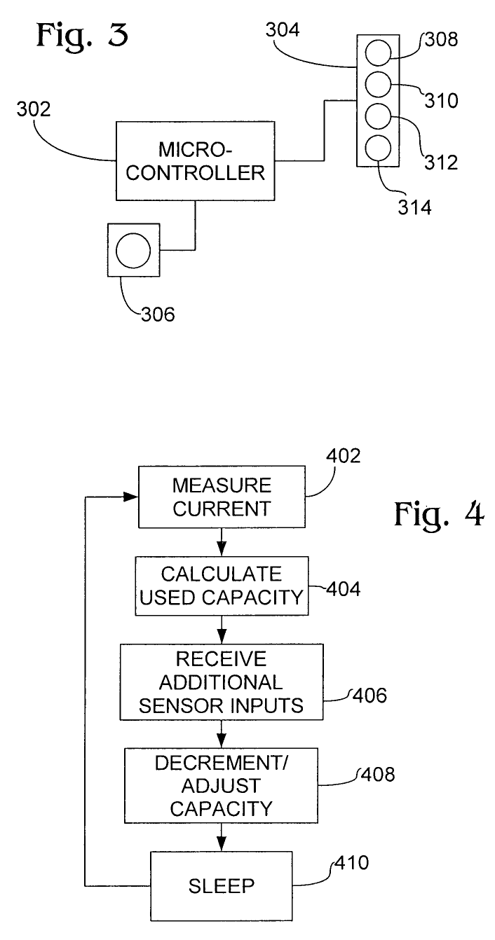

A representative method based on computer-executable instructions stored in a memory either as part of the microprocessor or as an external memory is illustrated in FIG. 4. In a step 402, a current measurement is obtained by sampling current flow at a sampling time. In a step 404, total battery delivered charge (typically as amp-hrs, Coulombs, or other charge dependent quantity) is estimated based on the sensed current. In a step 406, inputs from one or more additional sensors can be obtained. Such sensors can be associated with humidity, atmospheric pressure, or other environmental or operational factors. In a step 408, remaining battery capacity is estimated or corrected based on the sensed current and/or environmental or other values and an updated battery capacity store in a memory. Typically a previously stored capacity is decremented by the extracted charge associated with a current measurement, but capacity can also be changed based on other factors. Although the updated capacity is available, the updated capacity is typically not visually or otherwise announced to a user unless requested in order to reduce power consumed by battery monitoring. In some examples, a visual or audible alarm is provided, but because this alarm can be missed by a user, the stored capacity value is generally retained for presentation to the user upon user request. In a step 410, the sensing system enters a “sleep” mode that is associated with lower power operation. For example, a current sensor can be disabled during a sleep cycle. This sequence of steps is repeated periodically as indicated in FIG. 4. In a convenient example, current sensing circuitry is turned off during the sleep cycle, and a microprocessor or other control circuitry operates in a reduced power mode. In this way, battery monitoring can be performed using the battery being monitored as a power source for monitoring circuitry without substantially reducing battery life.

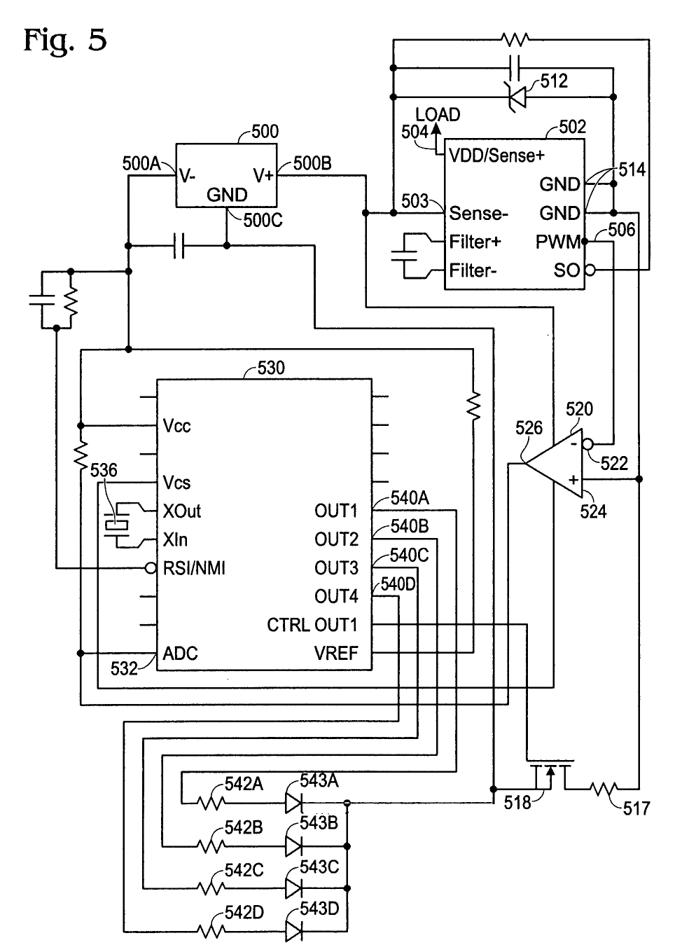

A representative example of battery monitor circuitry is illustrated in FIG. 5. As shown in the example of FIG. 5, a battery 500 is configured to provide −12 V and +12V at battery terminals 500A, 500B, respectively, and a ground reference at a battery terminal 500C. A current sensor module 502 is coupled to the battery 500 at a current sense input terminal 503 to receive a current from the battery and provide an output current at a current output terminal 504 that is in turn coupled to a load to be operated by the battery 500. In an example, the current sensor is an LM3812 current gauge integrated circuit that is available from National Semiconductor. An output signal indicative of the current provided from the output terminal 503 is delivered to a sensed current output terminal 506. This output signal can be conveniently provided as a pulse width modulated (PWM) signal having a pulse width associated with the sensed current.

The current sensor 502 is coupled to the positive battery terminal 500B to supply a positive power supply voltage VDD to the current sensor 502 at the input terminal 503. Ground input terminals 514 of the current sensor 502 are coupled to the battery terminal 500C via a zener diode 512. The zener diode 512 is typically a 3.3 V zener diode that provides about a 3.3 V potential difference between the terminals 503, 514 so as to provide power to the current sensor 502 from the battery 500. A resistor 516 is coupled to limit current through the zener diode 512. The resistor 516 is coupled to the battery ground terminal 500C with a MOSFET 518 that can be selectively switched to provide power to or disable the current sensor 502. In the example of FIG. 5 and other typical examples, the battery terminal 500B provides a total potential difference of about 12 V with respect to ground, so that the terminals 514 are not at battery ground potential but are virtual grounds.

A comparator 520 is coupled to receive electrical power from the battery terminals 500B, 500C and to receive the PWM sensed current signal at a first input terminal 522 and a virtual ground reference potential at a second input terminal 524. A PWM output signal that is referred to battery ground is delivered to a comparator output terminal 526.

A microprocessor 530 is coupled to the battery terminals 500A, 500B and to receive the sensed current signal from the comparator 520 at an analog-to-digital converter (ADC) input 532. The microprocessor 530 is configured to estimate an anticipated remaining battery capacity based on the sensed current signal. In one example, the microprocessor 530 is an MSP430x11x2 microprocessor available from Texas Instruments. The microprocessor 530 executes instructions at a rate associated with a clock signal established with a crystal 536. A convenient clock rate is 32.768 Hz. A 15 bit timer operating at this rate overflows once per second and thus provides a convenient time reference, but other clock rates can be used.

The microprocessor 530 is configured to periodically enter a sleep mode and disable the current sensor 502 to reduce battery drain. During sleep mode, a clock timer that includes the crystal 536 continues to run, and random access memory (typically part of the microprocessor) remains active. The MOSFET 518 is coupled to a digital output of the microprocessor that biases the MOSFET 518 so as to turn off the current sensor 502. In a representative implementation, a current of about 8 μA is required during sleep mode, and sleep mode occupies about 95% of total cycle time. In other examples, average current consumed by battery monitoring can be less than about 15 μA, 10 μA, or 8 μA.

After a predetermined number of clock cycles or a selected sleep time, the microprocessor 530 returns to normal operation and the current sensor 502 is enabled. Sleep and current sensing operational modes continue to alternate, typically at a fixed periodic rate of between about 0.1 Hz and about 10 Hz. In some examples, the periodic rate or other current sampling configuration can be selected based on a current response of the battery so that current samples satisfactorily represent actual current drawn from the battery and current spikes or other time-varying current demands are adequately represented by the samples.

In the example of FIG. 5, the −12 V and +12 V outputs of the battery are used. In some examples, battery monitoring circuitry is arranged to draw approximately the same time-averaged current from each so that the battery is uniformly depleted. In other examples, positive and negative voltage supply usage can be unbalanced, or only one can be used.

In the disclosed examples, battery monitors include a microprocessor or other controller configured to estimate remaining battery life based on previously extracted charge and other parameters associated with battery use, stored battery characteristics provided by a battery manufacturer or based on battery history or measurements of battery characteristics, and environmental conditions such as temperature, humidity, oxygen availability, pressure, or other characteristics. Such factors can be associated with a complex relationship among battery parameters and available capacity, and a microprocessor can be configured produce estimates using neural networks or other algorithms. For example, the microprocessor 530 can be programmed for a variety of battery configurations including battery capacities, voltages, cell types, and environments and operating conditions. While for some battery types, voltage sensing is unnecessary or of limited use, such information can be provided if desired. Battery capacity can be determined based on neural network algorithms implemented in computer-executable instructions for the microprocessor 530 or in circuit components as described in U.S. Pat. No. 7,080,054 that is incorporated herein by reference, or determined in other ways by the microprocessor 530.

In the example of FIG. 5, an indication of available remaining battery capacity can be provided. Digital outputs 540A-540D of the microprocessor 530 are coupled to current limiting resistors 542A-542D and light emitting diodes 543A-543D, respectively. Based on a charge determination, the digital outputs activate one or more of the LEDs 543A-543D. In view of the many possible embodiments to which the principles of the disclosed technology may be applied, it should be recognized that the illustrated embodiments are only representative examples and should not be taken as limiting the scope of the technology. We claim as our invention all that comes within the scope and spirit of the appended claims.

We claim:

1. An apparatus, comprising:
a current sensor configured to detect a battery current and provide an associated sensed current signal; and
a controller coupled to receive the sensed current signal and determine battery capacity usage in a corresponding time interval, and further configured to estimate a remaining battery capacity based on the battery capacity usage and a stored battery capacity, wherein the current sensor and the controller are coupled so as to be powered by the battery.

2. The apparatus of claim 1, further comprising an indicator configured to communicate the estimated battery capacity to a user in response to a user request.

3. The apparatus of claim 1, wherein the controller is configured to alternately establish a sleep mode in which the current sensor is disabled and power consumption of the controller is reduced and a sensing mode in which battery current is sensed.

4. The apparatus of claim 3, wherein the current sensor is configured to provide the sensed current signal as a pulse width modulated signal, and the controller includes an analog to digital converter configured to establish a digital representation of the sensed current signal, and the estimated remaining battery capacity is determined based on the digital representation.

5. The apparatus of claim 2, wherein the current sensor is configured to periodically detect the battery current and provide periodic sensed current signals, wherein the controller is configured to operate at a reduced power setting between the periodic detections.

6. The apparatus of claim 2, wherein the indicator is a visual indicator.

7. The apparatus of claim 4, wherein the indicator includes at least one light emitting diode that is activated based on the estimated remaining battery capacity.

8. The apparatus of claim 2, further comprising an oxygen sensor coupled to the controller and configured to detect battery activation.

9. The apparatus of claim 6, wherein the controller includes a memory configured to store a capacity of the battery.

10. A method, comprising:
alternately detecting a current provided by a battery with a current sensor and substantially disabling the current sensor; and
based on the periodically detected current, estimating a remaining battery capacity.

11. The method of claim 10, further comprising storing an initial battery capacity and determining the remaining battery capacity based on the initial battery capacity.

12. The method of claim 10, further comprising periodically storing an updated battery capacity based on the periodically detected current.

13. The method of claim 12, further comprising determining the remaining battery capacity based on at least one environmental sensor.

14. The method of claim 11, wherein a ratio of a time interval associated with current sensing to a time interval associated with the disabled current sensor is less than about 0.1.

15. The method of claim 11, further comprising providing electrical power to the current sensor with the battery.

16. An apparatus, comprising:
a battery; and
a periodically activated current sensing system coupled to the battery and configured to receive operational electrical power from the battery and to provide an estimate of remaining battery capacity based on periodically sensed current values.

17. The apparatus of claim 16, wherein the current sensing system includes a memory configured to store an initial battery capacity, and the estimate of remaining battery capacity is based on the initial battery capacity.

18. The apparatus of claim 16, further comprising a battery activation sensor that is coupled to indicate battery activation, wherein the remaining battery capacity is estimated based on an elapsed activation time.

19. The apparatus of claim 16, further comprising a voltage regulator configured to provide an operational voltage to the current sensing system.

20. The apparatus of claim 19, wherein the current sensor includes a microprocessor and a field effect transistor configured to periodically disable the current sensor.

21. The apparatus of claim 19, wherein the battery is a zinc-air battery.
